(19) United States
(12) Patent Application Publication
(10) Pub. No.: US 2024/0306663 A1
(43) Pub. Date: Sep. 19, 2024

(54) FOOD ITEM WHICH ATTACHES TO A CONTAINER EDGE

(71) Applicant: Magdalen Bolliger, Seattle, WA (US)

(72) Inventor: Magdalen Bolliger, Seattle, WA (US)

(21) Appl. No.: 18/512,698

(22) Filed: Nov. 17, 2023

Related U.S. Application Data
(63) Continuation of application No. 18/120,477, filed on Mar. 13, 2023, now abandoned.

(51) Int. Cl. A23G 3/56

(52) U.S. Cl. CPC A23G 3/566

(57) ABSTRACT

A food item which attaches to a container edge is shown and described. The container includes an inner wall and an external wall terminating in a top edge. The food item includes a body, which has a channel through a bottom portion thereof. The channel secures about the top edge of the container. The body sits on the food container such that more than 50 percent of the mass of the body is located above the edge of the food container. The channel creates three points of contact between the food item and the container. One between a first side of the channel and the inner wall of the food container. A second, between a second side of the channel opposing the first side and the outer wall of the food container. A third, between the top edge of the food container and a top surface of the channel.

### BACKGROUND OF THE INVENTION

The present invention relates to food items connected to mugs or other food containers. More particularly, the present invention provides for various food items to be molded and created such that they can be attached to a lip of a mug or other container. The food item will appear to be sitting, or otherwise positioned on the top edge of the lip.

When it comes to food people are always looking for new ways to present items in a creative and decorative fashion. It can be difficult to decorate a mug of coffee or a bowl of soup due to the small surface areas provided around the rim of the bowl or much. Further, if the decorations are not positioned just so, they may enter the contents of the container. If the decorations are not also a food product they could create and unappealing contents.

In another instance, for example in a party setting, often times there are foods served which are accompanied by dips or drinks. Usually, people spend most of their time standing or mingling in these situations. This can make it extremely difficult to eat the provided foods. Further, holding a drink and eating can be near impossible.

Consequently, there is a need for an improvement in the art of food items. The present invention substantially diverges in design elements from the known art while at the same time solves a problem many people face when attempting to decorate a mug or attached a food item thereto. In this regard the present invention substantially fulfills these needs.

### SUMMARY OF THE INVENTION

The present invention provides a food item which attaches to a container edge wherein the same can be utilized for providing convenience for the user when service or decorating food items. The food item which attaches to a container edge where the container includes an inner wall and an external wall terminating in a top edge. The food item includes a body which has a channel through a bottom portion thereof. The channel is configured to secure about the top edge of the container.

Another object of the food item which attaches to a container edge is to have the body sits about the edge of the food container such that more than 50 percent of the mass of the body is located above the edge of the food container.

Another object of the food item which attaches to a container edge is to have the channel create three points of contact. A first contact point being between a first side of the channel and the inner wall of the food container. A second contact point being between a second side of the channel opposing the first side and the outer wall of the food container. A third contact point being between the top edge of the food container and a top surface of the channel.

Another object of the food item which attaches to a container edge is to have body take the shape of an item from the list consisting of a real character, a created character, a plant, a work tool, an animal, a letter, a numeric character, a building and a vehicle.

Another object of the food item which attaches to a container edge is to have a chosen body shape include legs and have the legs form the channel.

Another object of the food item which attaches to a container edge is to have the food container be a drinking vessel.

Another object of the food item which attaches to a container edge is to have the food item be an item from the list consisting of chocolate, candy, sugar, cake, and bread.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a food item which attaches to a container edge.

FIG. 2 shows a perspective view of several embodiments of food items which attaches to a container edge.

FIG. 3 shows a side view of an embodiment of an embodiment of the perspective view of an embodiment of a food item which attaches to a container edge.

FIG. 4 shows a perspective view of an embodiment of a mold for the food item which attaches to a container edge.

### LIST OF REFERENCE NUMERALS

With regard to the reference numerals used, the following numbering is used throughout the drawings.

| | |
|---|---|
| 100 | Food Container |
| 101 | Base |
| 102 | Inner Wall |
| 103 | External Wall |
| 104 | Top Edge |
| 110 | Food Item |
| 111 | Body |
| 112 | Channel |
| 112a | First Side Wall |
| 112b | Second Side Wall |
| 112c | Top Surface |
| X | Dimension |
| 401 | Mold |
| 402 | Protrusion |

### DETAILED DESCRIPTION OF THE INVENTION

Reference is made herein to the attached drawings. Like reference numerals are used throughout the drawings to depict like or similar elements of the food item which attaches to a container edge. For the purposes of presenting a brief and clear description of the present invention, a preferred embodiment will be discussed as used for the food item which attaches to a container edge. The figures are intended for representative purposes only and should not be considered to be limiting in any respect.

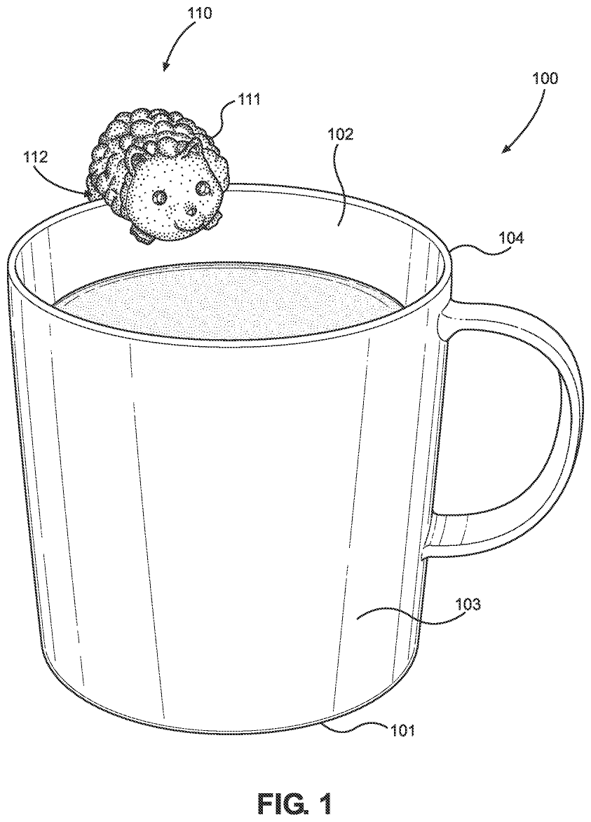

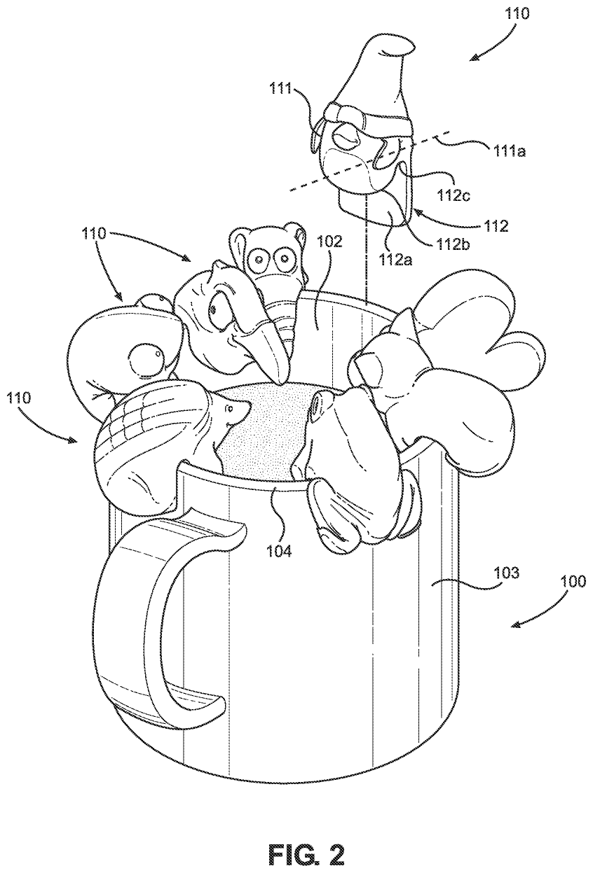

Referring now to FIG. 1 and FIG. 2, there is shown perspective views of several embodiments of food items which attaches to a container edge. In one embodiment the food item is meant to attach to an edge of a food container. The food container 100 will have a base 101 having an inner wall 102 and an external wall 103 extending therefrom. The inner wall 102 and the external wall 103 will terminate in a top edge 104. In one embodiment the food container 100 is a drinking vessel such as a mug or coffee cup. In another embodiment the food container 100 is a bowl.

The food item 110 is configured to secure about the edge of the food container 100. In one embodiment the food item 110 is configured such that a majority of the mass of the food item 110 will rest above the edge of the food container 100. In one embodiment a majority means more than 50 percent. The food item 110 includes a body 111.

In different embodiments the body 111 may be configured to resemble any number of items. In one embedment the body 111 is configured to represent an animal. In another embodiment the body 111 resembles a bow. In yet other embodiment, for example, the body 111 may represent real character, a created character, a plant, a work tool, a letter, a numeric character, a building and a vehicle. Further in various embodiments the body 111 can be made up of different food types. In one embodiment the body 111 is made from chocolate. In other embodiments the body 111 is made from items such as fruit, cake, bread, sugar, or other food items capable of holding shape.

A channel 112 is located through a lower portion 111a of the body 111, or otherwise, the bottom of the body 111. The channel 112 includes a first side wall 112a opposite a second sidewall 112b. The channel 112 further includes a top surface 112c opposite the channel opening. The channel 112 is configured to sit about the food container 100.

In different embodiments the channel 112 will contact various locations of the food container 100 holding the food item 110 in place. In one embodiment a first contact point is between the first side wall 112a of the channel and the inner wall 102 of the food container 100. A second contact point is between the second side wall 112b of the channel 112 and the outer wall 103 of the food container 100. A third contact point is between the top edge 104 of the food container 100 and a top surface of the channel 112c.

In different embodiments the food item 110 may have a face. In these embodiments the channel 112 may be configured such that the food item 110 may sit on the container having its face point in toward the center of the container or out away from the center of the container. Further, in different embodiment food items 110 may take the form on an object with a tail or other appendage which hangs down. In some embodiments the bottom of the food item 110 is flat and will not have an item which hangs down below that of the others. The channel 112 is significant enough to balance the food item 110 about the container top edge 104.

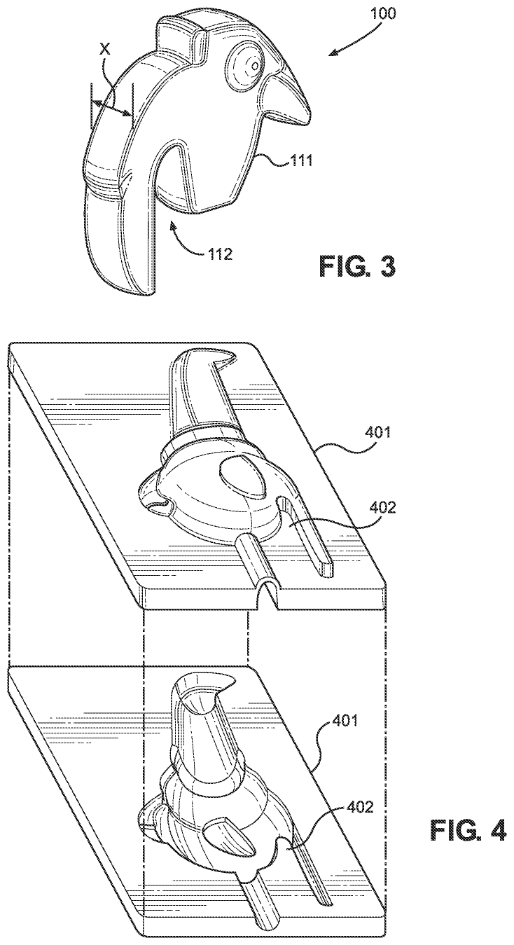

Referring now to FIG. 3, there is shown a side view of an embodiment of the perspective view of an embodiment of a food item 110 which attaches to a container edge. In some embodiments like those of FIG. 1 and FIG. 2, the body 111 of the food items 110 are three dimensional. In other embodiments like those of FIG. 3 the body 111 of the food item 110 can be more two dimensional. While the food item 110 will still have a right to create at least a thickness the overall food item 110 may only have decorative features along one side. This means that from other angles the food item 110 may not appear as more than a block or square.

In the shown embodiment the overall food item 110 resembles a bird. However, there are only details such as defining lines and layers along one side. However, the thickness X is only a few millimeters. This thickness X will prevent the food item 110 from tipping sideways when secured to the food container 100. In this embodiment the body 111 still has a channel 112 as described above. The channel 112 will still secure the body 111 about the top edge of a food container 100.

Referring now to FIG. 4, there is shown a perspective view of an embodiment of a mold for the food item which attaches to a container edge. In one embodiment the food item 110 is created via a mold 401. The mold 401 may be an open-faced mold or a full closed mold. In either embodiment the mold 401 will contain the desired shape for the body 111. The mold 401 will also include a protrusion 402. The protrusion 402 will ensure proper creation of the channel. In one embodiment the mold 401 is made from a flexible material to allow for easier removing of the food item. In yet another embodiment the mold 401 is specifically made from silicon.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A food item which attaches to a container edge where the container comprises an inner wall and an external wall terminating in a top edge, the food item comprises:
a body, wherein the body is made from an edible material;
the body has a channel through a bottom portion thereof;
wherein the channel is configured to secure about the top edge of the container.

2) The food item which attaches to a container edge of claim 1, wherein the body sits about the edge of the food container such that more than 50 percent of the mass of the body is located above the edge of the food container.

3) The food item which attaches to a container edge of claim 1, wherein the channel creates three points of contact;
a first contact point being between a first side of the channel and the inner wall of the food container;
a second contact point being between a second side of the channel opposing the first side and the outer wall of the food container;
a third contact point being between the top edge of the food container and a top surface of the channel.

4) The food item which attaches to a container edge of claim 1, wherein the body takes the shape of an item from the list consisting of a real character, a created character, a plant, a work tool, an animal, a letter, a numeric character, a building and a vehicle.

5) The food item which attaches to a container edge of claim 1, wherein a chosen body shape includes legs and the legs form the channel.

6) he food item which attaches to a container edge of claim 1, wherein the food container is a drinking vessel.

7) The food item which attaches to a container edge of claim 1, wherein the food item is an item from the list consisting of chocolate, candy, sugar, cake, and bread.

8) A food item which attaches to a container edge where the container comprises an inner wall and an external wall terminating in a top edge, the food item consists of:
a body, wherein the body is made from an edible material;
the body has a channel through a bottom portion thereof;
wherein the channel is configured to secure about the top edge of the container; and
wherein the body sits about the edge of the food container such that more than 50 percent of the mass of the body is located above the edge of the food container.

9) A three dimensional food item which attaches to a container edge, the food item comprises:
a body, wherein the body is made from an edible material; and
wherein the body forms the shape of a three dimension object;
the body has a channel through a bottom portion thereof;
wherein the channel is configured to secure about the top edge of the container.

10) The food item which attaches to a container edge of claim 9, wherein the body sits about the edge of the food container such that more than 50 percent of the mass of the body is located above the edge of the food container.

11) The food item which attaches to a container edge of claim 9, wherein the channel creates three points of contact;
a first contact point being between a first side of the channel and the inner wall of the food container;
a second contact point being between a second side of the channel opposing the first side and the outer wall of the food container;
a third contact point being between the top edge of the food container and a top surface of the channel.

12) The food item which attaches to a container edge of claim 9, wherein the body takes the shape of an item from the list consisting of a real character, a created character, a plant, a work tool, an animal, a letter, a numeric character, a building and a vehicle.

13) The food item which attaches to a container edge of claim 9, wherein a chosen body shape includes legs and the legs form the channel.

14) The food item which attaches to a container edge of claim 9, wherein the food container is a drinking vessel.

15) The food item which attaches to a container edge of claim 9, wherein the food item is an item from the list consisting of chocolate, candy, sugar, cake, and bread.
